(19) United States
(12) Patent Application Publication
(10) Pub. No.: US 2012/0253898 A1
(43) Pub. Date: Oct. 4, 2012

(54) METHOD AND APPARATUS FOR PROVDING COUPON INFORMATION VIA RING-BACK SIGNAL

(75) Inventor: Bernard BERUS, Berlin (DE)

(73) Assignee: NOKIA CORPORATION, Espoo (FI)

(21) Appl. No.: 13/076,809

(22) Filed: Mar. 31, 2011

(51) Int. Cl. G06Q 30/00; H04M 3/42

(52) U.S. Cl. 705/14.4; 455/414.1

(57) ABSTRACT

An approach is provided for delivering one or more coupon and/or other information via a ring-back signal. One or more communication networks and/or one or more services platforms receive one or more requests for one or more coupon and/or other information and cause, at least in part, delivery of one or more coupon and/or other information via a ring-back signal on one or more communication channels.

### BACKGROUND

Service providers and device manufacturers (e.g., wireless, cellular, etc.) are continually challenged to deliver value and convenience to consumers by, for example, providing compelling network services. Such services can often include shopping services and/or related marketing services. One area of interest has been the development of services that facilitate marketing promotions or discounts (e.g., coupons or other similar discount offers) provided from retailers and/or service providers to users. As a result, coupons and related discount offers have proliferated and delivered to users via many different delivery solutions. Accordingly, service providers and device manufacturers face significant technical challenges to enabling users to efficiently discover and share coupons.

### SOME EXAMPLE EMBODIMENTS

Therefore, there is a need for an approach for users to receive coupon and/or other information via a more economical method.

According to one embodiment, a method comprises processing and/or facilitating a processing of one or more messages of one or more applications, one or more services, or a combination thereof for presentation in at least one ring-back media file. The method also comprises determining to associate the at least one ring-back media file to at least one communication channel associated with (a) the one or more applications, (b) the one or more services, (c) at least one user of the one or more applications or the or more or services, or a combination thereof, wherein a request to initiate a communication session over of the at least one communication channel causes, at least in part, a presentation of the at least one ring-back media file pending an establishment of the communication session.

According to another embodiment, an apparatus comprising at least one processor, and at least one memory including computer program code, the at least one memory and the computer program code configured to, with the at least one processor, cause, at least in part, the apparatus to process and/or facilitate a processing of one or more messages of one or more applications, one or more services, or a combination thereof for presentation in at least one ring-back media file. The apparatus is also caused to determine to associate the at least one ring-back media file to at least one communication channel associated with (a) the one or more applications, (b) the one or more services, (c) at least one user of the one or more applications or the or more or services, or a combination thereof, wherein a request to initiate a communication session over of the at least one communication channel causes, at least in part, a presentation of the at least one ring-back media file pending an establishment of the communication session.

According to another embodiment, a computer-readable storage medium carrying one or more sequences of one or more instructions which, when executed by one or more processors, cause, at least in part, an apparatus to process and/or facilitate a processing of one or more messages of one or more applications, one or more services, or a combination thereof for presentation in at least one ring-back media file. The apparatus is also caused to determine to associate the at least one ring-back media file to at least one communication channel associated with (a) the one or more applications, (b) the one or more services, (c) at least one user of the one or more applications or the or more or services, or a combination thereof, wherein a request to initiate a communication session over of the at least one communication channel causes, at least in part, a presentation of the at least one ring-back media file pending an establishment of the communication session.

According to another embodiment, an apparatus comprises means for processing and/or facilitating a processing of one or more messages of one or more applications, one or more services, or a combination thereof for presentation in at least one ring-back media file. The apparatus also comprises means for determining to associate the at least one ring-back media file to at least one communication channel associated with (a) the one or more applications, (b) the one or more services, (c) at least one user of the one or more applications or the or more or services, or a combination thereof, wherein a request to initiate a communication session over of the at least one communication channel causes, at least in part, a presentation of the at least one ring-back media file pending an establishment of the communication session.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of requesting, receiving and providing coupon and/or other information, according to one embodiment;

FIG. 2 is a diagram of the components of user equipment capable of requesting and receiving coupon and/or other information, according to one embodiment;

FIG. 3 is a diagram of the components of a coupon services platform 103, according to one embodiment;

FIGS. 4A-4B are flowcharts of processes for requesting/receiving coupon and/or other information, according to one embodiment;

FIGS. 5A-5C are diagrams of user interfaces utilized in the processes of FIGS. 3-4, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for receiving coupon and/or other information via a ring-back signal of a communication channel. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein the term “coupon” refers to a document, file, token, etc. that can be presented to receive a discount or rebate related to a transaction for goods and/or services. Although various embodiments are discussed with respect to delivering coupon and/or other information via a ring-back signal, it is contemplated that the embodiments of the delivery process described herein are also applicable to any item that can be delivered including, but not limited, to physical items, electronic items, goods, services, other items in commerce, and the like. Further, a ring-back signal refers to a signal (e.g., audio signal/tone) delivered on a communication channel to a calling party while waiting for the called party and/or device to cause the call to connect. For example, when calling party “A” places a call to party “B”, the communication network delivers a ring-back signal (e.g., audio tone) to party “A” while party “A” is waiting for party “B” and/or a device at party “B” to connect (e.g., answer) the call.

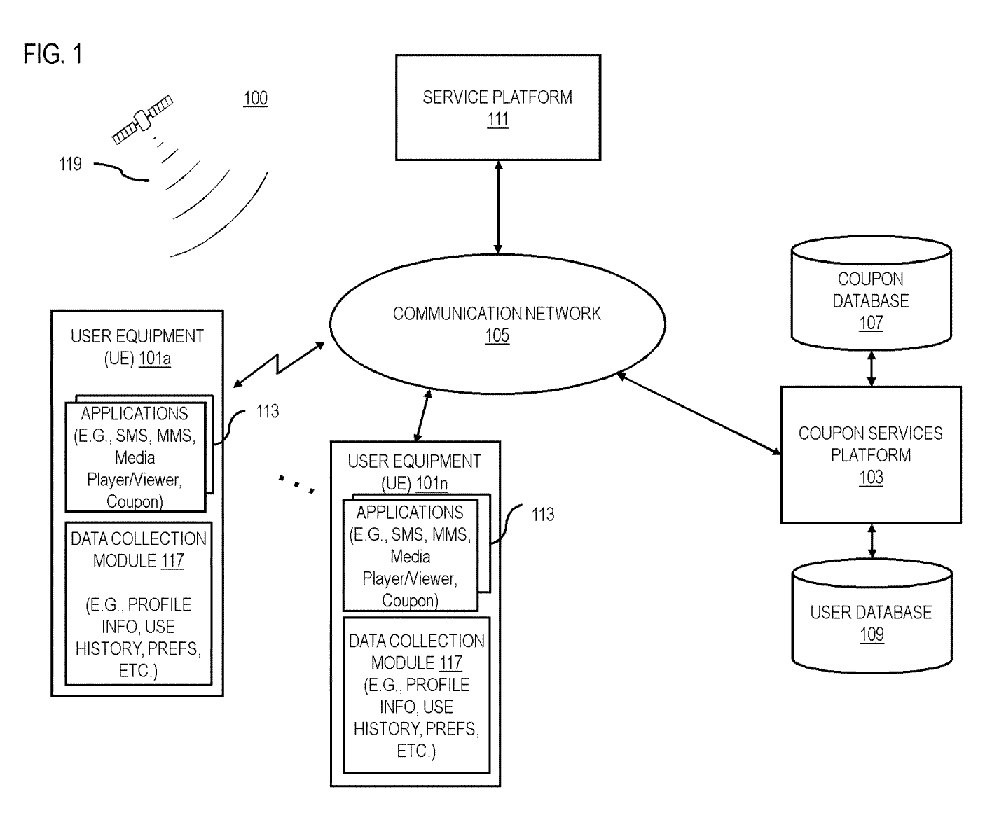

FIG. 1 is a diagram of a system capable of delivering coupon and/or other information via a ring-back signal, according to one embodiment. Traditionally, coupons often have limitations or other conditions with respect to, for instance, which merchants will accept the coupons, method of requesting/receiving, validity period, applicable products, etc. One popular method for requesting/receiving the coupon information is to utilize a user device (e.g., a phone) to connect to a communications network for calling and/or connecting to related internet however, users can incur costs for connecting via one or more communication networks, which sometimes require additional service plans such as a data plan with additional costs and/or airtime (e.g., minutes used). Thus, users and merchants can benefit from a method whereby the coupon information can be delivered to the user without any additional costs to the user. Further, a user may be more inclined to request and utilize coupon information if the process for requesting and receiving the coupon information is simplified and at no cost to the user.

To address this problem, a system 100 of FIG. 1 introduces the capability to request and/or receive the coupon and/or other information at no additional cost to a user. For example, a user can call a phone number to receive one or more coupon or other information whereby the communication network will deliver the coupon information via a ring-back signal without connecting the call to a party and/or a device and therefore avoiding any potential network connection cost to the user. Although various embodiments are discussed with respect to a ring-back signal provided for voice calls, it is contemplated that the various embodiments are applicable to other forms of communications such as video calls or communications where there is a delay period between a communication request and establishment of the communication session. In one embodiment, the system 100 supports network operators and users in delivering and receiving, respectively, coupon information via ring-back signal in a communication network, which is effectively unused network time. In one embodiment, the coupon information (e.g., a product, a discount amount, a merchant information, etc.) is provided to the user once the user initiates a call to a service provider.

Because the user can receive the coupon or other information as a ring-back signal before the communication is actually established, the user would generally not incur any communication costs. In one embodiment, the ring-bank signal may instruct the user to terminate the communication session before the session is established (e.g., before the terminating device answers the call) to avoid connection costs. In yet another embodiment, the system 100 or service provider can configure the communication request to have an extended delay to support the ring-back signal before connecting the request. In other embodiments, the communication request may be automatically terminated following presentation of the ring-back signal.

For example, a user calls a specific phone number whereby a network operator, via the communication network 105 (e.g., central switching control), provides one or more coupon information during a period when a ring-back signal would normally be active on the communication channel; the user receives the one or more coupon information in the form of audio (e.g., for voice calls), video (e.g., for video calls), text (e.g., for over internet protocol sessions and/or teletypewriter (TTY) technology) and the like, and provides the information to the merchant (e.g., at point-of-sale) in order to redeem the one or more offerings made available via the coupon. The information (e.g., a phone number to call) required for obtaining the coupon information can be made available to the users by one or more merchants, one or more coupon services, one or more service platforms and the like via newspapers, magazines, internet, posters, signs and/or the like.

In one embodiment, the one or more coupon information is dynamically generated. For example, the coupon services platform 103 and/or the service platform 111 can control the coupon generation based on different criteria such as the number of total coupons to be generated, number of coupons generated so far, types of coupons available from one or more merchants, number and types of the coupons available for the area and/or the like. For example, there may be one hundred coupons available for a particular product at a particular merchant; however, the number and/or terms of the coupon can be modified according to response received from the users.

In another embodiment, the one or more coupon information is pre-generated. For example, a predetermined number of coupons, one or more types of coupons, participating merchants and/or the like. For example, there are two hundred available coupons offering users/participants to receive a free soda if they buy a hamburger between 1:00 PM and 2:00 PM at a particular establishment.

In another embodiment, the one or more coupon information is generated based on the user or context information associated with the user. For example, a user can have a dedicated phone number assigned to the user to call and receive one or more coupons. The one or more coupons can be based on one or more criteria identified by the user, the coupon services platform 103, the service platform 111 and/or the like. In some embodiments, the user context or information can be determined from a communication identifier (e.g., a phone number) of the user. For example, the system 100 can identify a phone number using a caller identification (ID) service. The phone number can then be parsed to determine an approximate location (e.g., via a reverse lookup of area code information, public directories, etc.). In another embodiment, the context information may include a time of day for the call or a number of times that the user has call for coupon information. Based, at least in part, on the context information, the system 100 can offer personalized coupons or information to the user.

In another embodiment, the one or more coupon information is generated based on the dialed phone number. For example, the phone number can be dedicated to providing one or more coupons based on a merchant, based on a product or a service, based on a geographical area and the like. For example, a phone number is can be dedicated to providing, predetermined or flexible, coupon offerings on a new product and/or service at one or more participating merchants.

As noted above, in some embodiments, the system 100 may provide information other than coupon information via various embodiments of the ring-back signal approach described herein. For example, the system 100 can provide local news, weather, bulletins, etc. which can also be customized based, at least in part, on the context of the user. It is contemplated that the system 100 can provide any information that can be presented via the ring-back signal.

In some embodiments, the ring-back signal may include encoded information or data, for example, via dual-tone multi-frequency (DTMF) signaling or other encoding scheme appropriate to the ring-back signal. In this way, user devices that are configured to decode the information or data from the ring-back signal can automatically process, store, or otherwise manipulate the information or data. In one embodiment, the processing, storage, and/or manipulation of the information or data in the ring-back signal can be performed without or with only minimal user intervention.

As shown in FIG. 1, user equipment (UEs) 101a-101n (also collectively referred to as UEs 101) can connect to a coupon services platform 103 over a communication network 105 to request and/or receive coupon information via a ring-back signal. In this example, the UEs 101a-101n can be associated with one or more services for searching or otherwise accessing coupon information. Moreover, the coupon services platform 103 can retrieve coupon templates and/or coupon information from a coupon database 107 and user context information, profile information, preferences, etc. from the user database 109 for performing context-based matching to trigger coupon information delivery. In other words, the databases 107 and 109 may be utilized to provide the coupon information delivery services to the UEs 101 and/or a services platform 111. In one embodiment, the UEs 101 can use an application 113 (e.g., a coupon application) to request and/or specify coupon information from one or more services.

In certain examples, the coupon services platform 103 can be implemented as part of the service platform 111 by a coupon provider (e.g., a retailer or seller) to share or otherwise specify coupon information. For example, a retail client 111 and/or UE 101 can be utilized to upload information about retail items 115 (e.g., retail items 115 associated with a retail store, other purchasable items such as goods and/or services, etc.) and related discount or coupon information to the coupon services platform 103. In this manner, coupon information and/or coupon templates, including coupon contributions and/or requests, can be transmitted to the coupon database 107 of the coupon services platform 103. In certain embodiments, the coupon information and/or templates may be defined and/or stored locally by the retail client 111 and/or UE 101 in, for instance, the retail items database 115.

In one embodiment, the discount database 107 may include information about one or more items (e.g., retail items) and associated coupon information. For example, the item database 109 may include categorical information associated with the items (e.g., products, services, etc.) The categorical information may be stored in a data structure (e.g., a tree) and include one or more subcategories. Further, the item database 109 can include a description of any discounts, coupons, promotions, etc. associated with one or more items of the database.

In another embodiment, profile information, discount use history, preferences, discount criteria, etc. as well as context information about a user participating in coupon access/validation, the UE 101, or a combination thereof can be collected and monitored at the coupon services platform 103 or the UE 101. In certain embodiments, an application 113 on the UE 101 can monitor the information (e.g., context data, user preferences, user criteria, user history, etc.) associated with a data collection module 117 of the UE 101. For example, the data collection module 117 may utilize applications, services, sensors, etc. to collect such information. Further, the context information can be any one of multiple types of information that can provide conditions that a user may use to specify coupon information or other information provided via the ring-back signal.

Depending on the type of communication network (e.g., voice communications, data communications, etc.), context information may include, for instance, location information, time information, camera information, microphone information, environmental sensor information, weather information, user calendar information, accelerometer information, compass information, body temperature information, etc. For example, in voice networks, context information may be limited to information that can be determined from phone numbers identified by, for instance, a caller ID service. As previously noted, such caller ID information can be used to determine the caller's approximate location, network of origin, etc. In other types of communication networks or networks with advanced capabilities, the data collection module 117 may have connectivity to a location determination sensor system, such as a Global Positioning System (GPS) to access GPS satellites 119 to determine context information (e.g., the location of the UE 101). The UE 101 may then cause transmission of the collected information (e.g., the profile information, discount use history, preferences, context information, etc.) to the coupon services 103 for processing to facilitate coupon information sharing. In one embodiment, the coupon services 103 can receive and store the information in a user profile associated with the user in the user database 109. In certain embodiments, the user profile may include an identifier of the user (e.g., a username) and/or an identifier of the UE 101 (e.g., a hardware identifier such as an International Mobile Equipment Identity (IMEI), a phone number, an Internet Protocol address, etc.).

In one embodiment, if the communication network 105 supports data exchange prior to communication establishment (e.g., during the ring-back signal period, access channel, control channel, etc.), each UE 101a-101n in the system 100 may transmit context information associated with the user of each respective UE 101a-101n to the coupon services platform 103. An application 113 (e.g., a coupon application) executing on one of the UEs 101 associated with a user can then utilize the information stored on the coupon services platform 103 to initiate coupon information delivery. The application 109 can receive an input specifying one or more criteria (e.g., attribute-condition pairs) to determine a context-based group from among a plurality of UEs 101 for coupon information delivery. This information can be transmitted via a communication network 105 to/from the coupon services platform 103. The coupon services platform 103 receives the input and may associate the input as a request to initiate coupon information delivery. The criteria can include one or more context attributes associated with UEs 101 along with one or more other parameters or conditions.

In certain embodiments, a context attribute is a type of user context or coupon characteristic. Examples include location, time, calendar information, accelerometer information, compass information, body temperature information, outside weather information, etc. In one example, the input can include criteria specifying that the user wishes to validate and/or receive coupon information based on the attribute-condition pairs related to the coupon and/or the context data of the user In another example, the input can include criteria specifying that the user wishes to validate and/or receive coupon information in a particular region (e.g., a particular distance from the user's home, in a particular area such as a park, etc.).

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof including the accessories and peripherals of these devices, or any combination thereof. It is also contemplated that the UE 101 can support any type of interface to the user (such as “wearable” circuitry, etc.).

By way of example, the UEs 101 and coupon services platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the coupon services platform 103 may interact according to a client-server model with the applications 113 of the UE 101. According to the client-server model, a client process sends a message including a request to a server process, and the server process responds by providing a service (e.g., context-based grouping, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

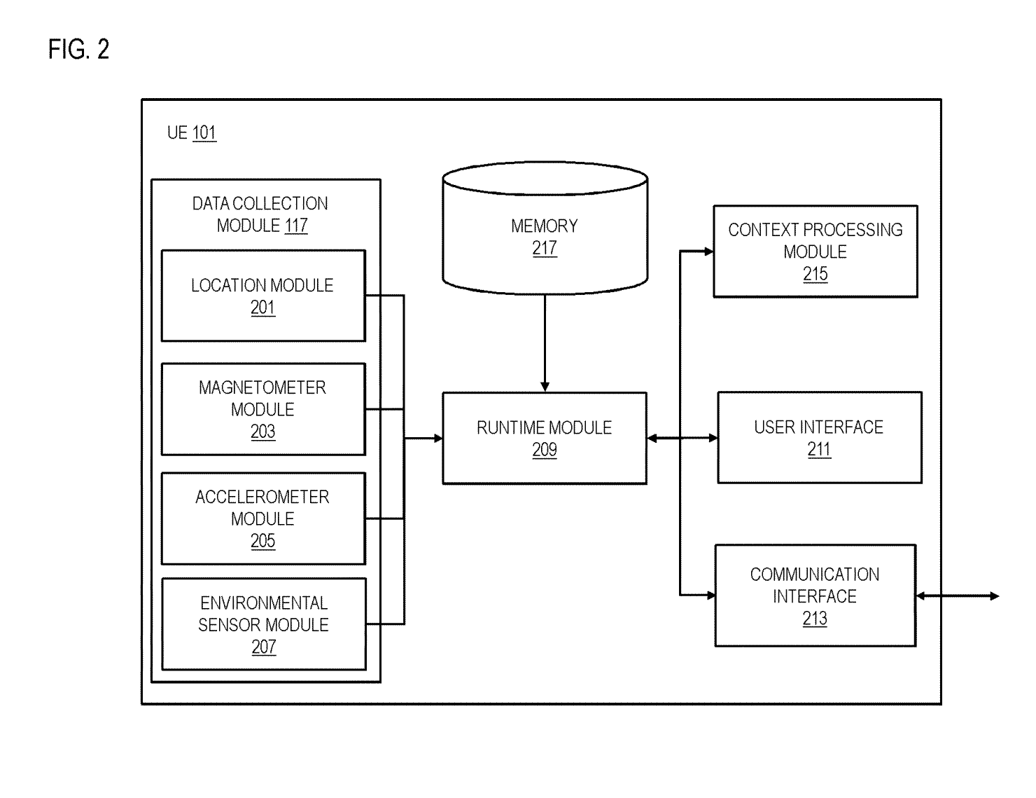

FIG. 2 is a diagram of the components of user equipment capable of requesting and receiving coupon information, according to one embodiment. By way of example, a UE 101 includes one or more components for requesting and/or receiving coupon information via a ring-back signal of a communication channel. It is contemplated that the functions of these components may be combined in one or more components or performed by other components of equivalent functionality. In this embodiment, the UE 101 includes a data collection module 117 that may include one or more location modules 201, magnetometer modules 203, accelerometer modules 205, environmental sensor modules 207, the UE 101 can also include a runtime module 209 to coordinate the use of other components of the UE 101, a user interface 211, a communication interface 213, a context processing module 215, and memory 217. An application 113 (e.g., a coupon information application) of the UE 101 can execute on the runtime module 209 utilizing the components of the UE 101.

The location module 201 can determine a user's location. The user's location can be determined by a triangulation system such as GPS, assisted GPS (A-GPS), Cell of Origin, or other location extrapolation technologies. Standard GPS and A-GPS systems can use satellites 119 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 217 and are transmitted to the coupon services platform 103 via the communication interface. Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 217 and/or transmitted via the communication interface 213 to the context processing module 215.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In one embodiment, vertical directional data obtained from an accelerometer is embedded into the metadata of captured or streaming media or otherwise associated with the UE 101 by the location services application 109. In certain embodiments, the magnetometer module 203 and accelerometer module 205 can be means for ascertaining a perspective of a user. This perspective information may be stored in the memory 217 and sent to the context processing module 215.

Moreover, the environmental sensor module 207 can determine atmospheric conditions surrounding the UE 101. Such atmospheric conditions may include humidity, temperature, body temperature of the user, other biometric data of the user, etc. Once again, this information can be stored in the memory 217 and sent to the context processing platform 103. In certain embodiments, information collected from the data collection module 111 can be retrieved by the runtime module 209 and stored in memory 217. Then periodically, the information can be transmitted to the context processing module 215.

In one embodiment, the communication interface 213 can be used to communicate with the coupon services platform 103 or other UEs 101. Certain communications can be via methods such as an internet protocol, messaging (e.g., SMS, MMS, etc.), or any other communication method (e.g., via the communication network 105). In some examples, the UE 101 can send context information associated with the UE 101 to the coupon services platform 103. In other examples, the user can utilize a user interface 211 to generate a request for and/or receive coupon information based on context from the coupon services platform 103.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc. In certain embodiments, the user interface 211 and/or runtime module 209 can be means for causing presentation of context-based coupon information results.

The context processing module 215 may be utilized in determining context information from the data collection module 117 and/or applications 113 executing on the runtime module 209. This information may be caused to be transmitted, via the communication interface 213 to the coupon services platform 103. The context processing module 215 may additionally be utilized as a means for determining groups based on input criteria and received context information associated with other UEs 101. In certain embodiments, the context processing module 215 can infer higher level context information from the context data such as favorite locations, significant places, common activities, etc.

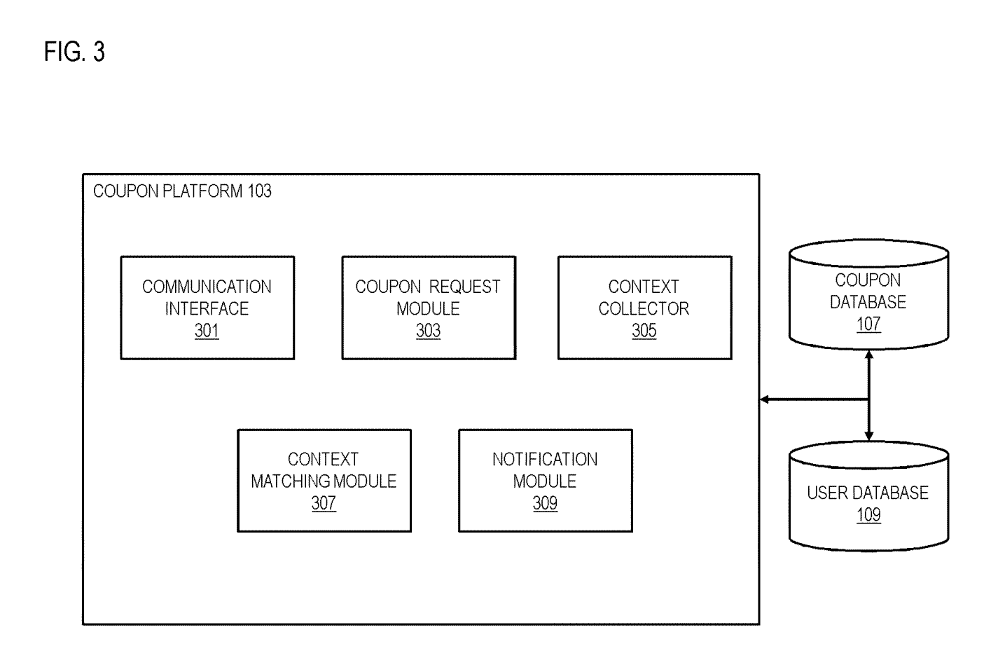

FIG. 3 is a diagram of the components of a coupon service, according to one embodiment. By way of example, the coupon services platform 103 includes one or more components for providing coupon information. It is contemplated that the functions of these components may be combined in one or more components or performed by other components of equivalent functionality (e.g., the discount module 215). In this embodiment, the coupon services platform 103 includes a communication interface 301, a coupon request module 303, a context collector 305, a context matching module 307, and a notification module 309. It is contemplated that all or a portion of the functions of the coupon services platform 103 may be performed by the application 113 of the UE 101 In one embodiment, the communication interface 301 can be used to communicate with a UE 101 as well as other devices connected on the communication network 105. For example, the communication interface 301 supports communications with one or more UEs 101 via ring-back signals. In one embodiment, the coupon services platform 103 can receive a request for and/or provide coupon information, user context information, user-specified templates, user profile information, and the like from the UE 101 via the communication interface 301 via methods such as internet protocol, MMS, SMS, GPRS, or any other available communication method. By way of example, the UE 101 may initiate one or more coupon information requests, context-based requests, and/or related information to the coupon services platform 103 to access context-based coupon information, such as to determine available coupons, determine participating merchants, update user profiles, update context data, etc. in the user database 109 and/or the coupon database 107. In one embodiment, these requests are initiated via a call to a phone number or other terminating point associated with the requested information (e.g., coupon) or operation (e.g., update context data).

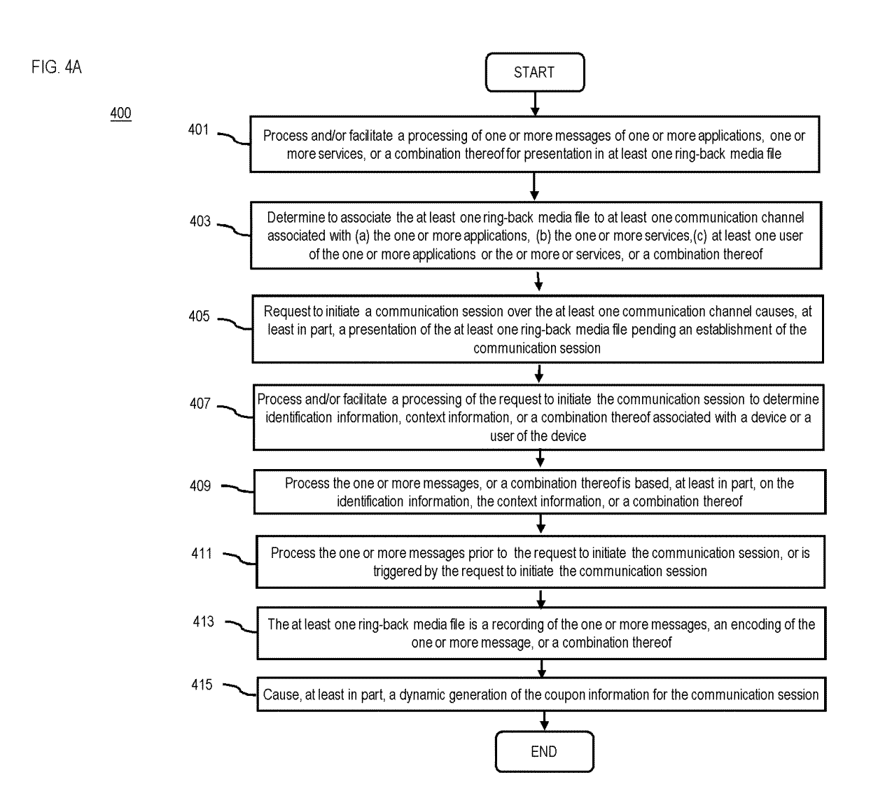

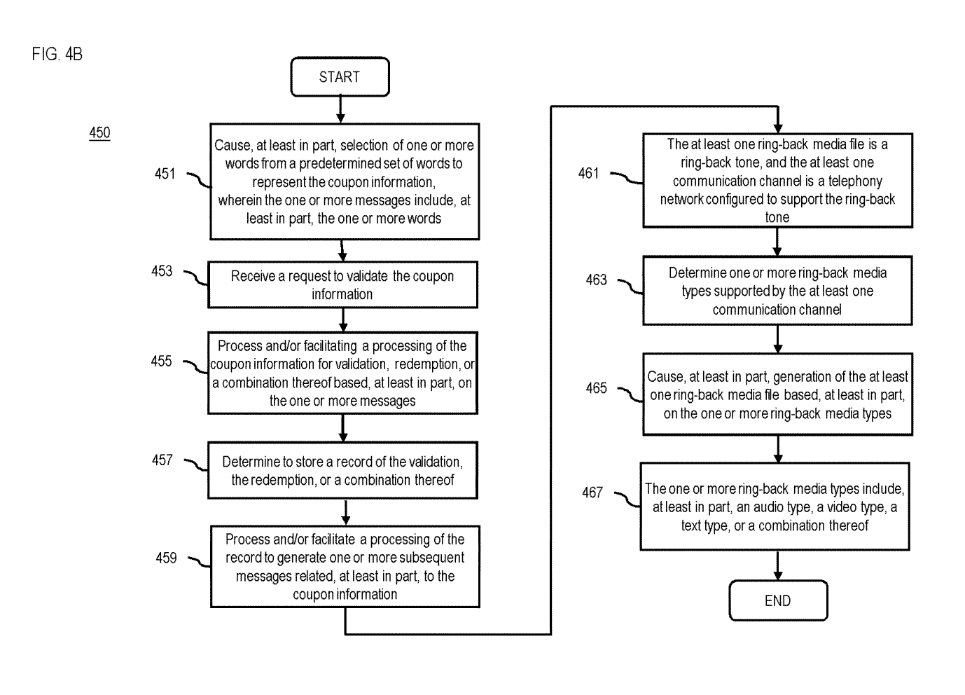

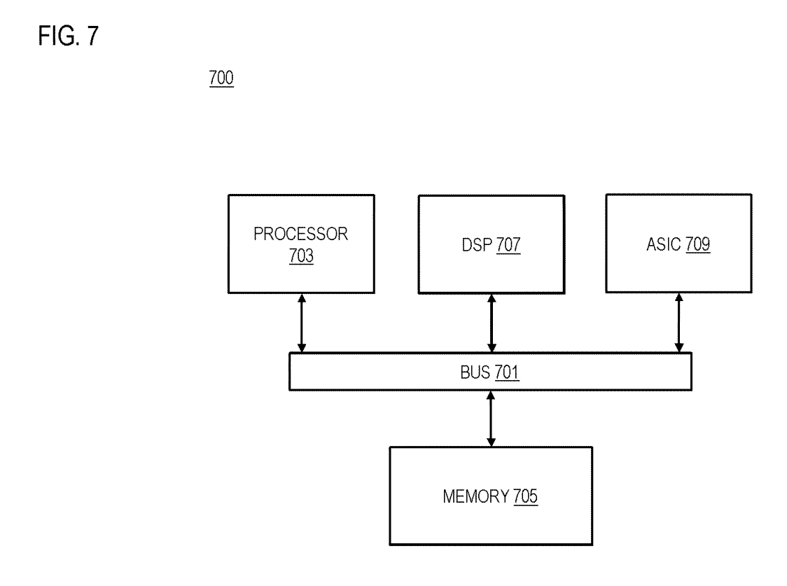

FIG. 4A is a flowchart of a process for requesting/receiving coupon information, according to one embodiment. In one embodiment, the coupon services platform 103 and/or an application 113 of the UE 101 performs the process 400 and is implemented in, for instance, a chip set including a processor and a memory as shown in FIG. 7. As such, the coupon services platform 103 and/or application 113 can provide means for accomplishing various parts of the process 400 as well as means for accomplishing other processes in conjunction with other components of the system 100. Throughout this process, the coupon services platform 103 is referred to as completing various portions of the process 400, however it is understood that the UE 101 can perform some of and/or all of the process steps.

In step 401, the communication network 105 processes and/or facilitates a processing of one or more messages of one or more applications, one or more services, or a combination thereof for presentation in at least one ring-back media file (e.g., a ring-back signal, ring-back tone, etc.) depending on the media supported by the communication network 105. The input can be received from the coupon services 103 and/or service platform 111. In one embodiment, the coupon services platform 103 provides one or more coupon information based on user attributes such as user location information. For example, the user location information is determined by information received from the UE 101 by the communication network 105 so that one or more coupon information are determined and delivered to the user.

In step 403, the communication network 105 determines to associate the at least one ring-back media file to at least one communication channel associated with (a) the one or more applications, (b) the one or more services, (c) at least one user of the one or more applications or the or more or services, or a combination thereof.

In step 405, UE 101 requests to initiate a communication session over the at least one communication channel which causes, at least in part, a presentation of the at least one ring-back media file pending an establishment of the communication session. In one embodiment, a user calls a phone number associated with a coupon service in order to receive one or more coupon information whereby the communication network causes presentation of one or more coupon information via the ring-back signal.

In step 407, the communication network 105 processes and/or facilitates a processing of the request to initiate the communication session to determine identification information, context information, or a combination thereof associated with a device or a user of the device. In one embodiment, one or more information such as user identity, user device type, user location and/or the like are determined so that one or more coupon information can be determined for delivery.

In step 409, the communication network 105 processes the one or more messages or a combination thereof is based, at least in part, on the identification information, the context information, or a combination thereof. In one embodiment, one or more coupon information are determined (e.g., selected, generated, etc.) based, at least in part, on the user identity, user device type, user location, user preferences. For example, one or more coupons are created based on the location of the user being at a specific merchant location.

In step 411, the coupon services 103, service platform 111 and/or the communication network 105 processes the one or more messages prior to the request to initiate the communication session, or is triggered by the request to initiate the communication session. In one embodiment, one or more coupon information are pre-determined and ready for delivery, for example, a 15% coupon is available for the next seven callers. In another embodiment, one or more coupon information are determined as the one or more coupon information requests are received, for example, a discount percentage/amount is reduced in every subsequent coupon delivered until the discount percentage/count reaches a set minimum.

In step 413, the at least one ring-back media file is a recording of the one or more messages, an encoding of the one or more message, or a combination thereof. In example embodiments, the coupon information is delivered via audio, video, text or a combination thereof such that the user and/or the user device can utilize the information (e.g., record, save, view, hear, present, etc.)

In step 415, the coupon services 103, service platform 111 and/or the communication network 105 causes, at least in part, a dynamic generation of the coupon information for the communication session. In one embodiment, the one or more coupon information are dynamically generated to provide, for example, for control of the coupon offerings such as total number of coupons, discount percentages, participating merchants, product types and the like. Such control can be beneficial to the merchants and/or the users by providing for flexibility.

FIG. 4B is a flowchart of a process for requesting/receiving coupon information, according to one embodiment. In one embodiment, the coupon services platform 103 and/or an application 113 of the UE 101 performs the process 450 and is implemented in, for instance, a chip set including a processor and a memory as shown in FIG. 7. As such, the coupon services platform 103 and/or application 113 can provide means for accomplishing various parts of the process 400 as well as means for accomplishing other processes in conjunction with other components of the system 100. Throughout this process, the coupon services 103 is referred to as completing various portions of the process 450, however it is understood that the UE 101 can perform some of and/or all of the process steps.

In step 451, the coupon services 103, service platform 111 and/or the communication network 105 causes, at least in part, selection of one or more words from a predetermined set of words to represent the coupon information, wherein the one or more messages include, at least in part, the one or more words. In one embodiment, the one or more messages include words/information about the coupon content such as one or more participating merchants, merchants' locations, information on products and/or services offered and the like. For example, the message can indicate a 10% discount on ladies' jeans available at the “Jeans Depot” available for the next 24 hours with a coupon code of “JEANS4LESS”.

In step 453, the coupon services 103, service platform 111 and/or the communication network 105 receive a request to validate the coupon information. In one embodiment, a user calls a phone number in order to receive further information for validating a coupon. For example, the user may have coupon information (e.g., discounts, availability time, date, etc.), but needs further validation information (e.g., a validation code) in order to utilize one or more offerings in one or more coupons.

In step 455, the coupon services 103 and/or service platform 111 process and/or facilitate a processing of the coupon information for validation, redemption, or a combination thereof based, at least in part, on the one or more messages. In one embodiment, one or more coupon information is provided to a user in a ring-back signal over a communication network 105 communication channel whereby the signal can be an audio signal, a video signal, text format signal or a combination thereof. In one example, the coupon information can be numeric, alphanumeric and/or one or more code words (e.g., green, blue, shoes, etc.) which correspond to one or more codes on file with the vendor.

In step 457, the coupon services 103, communication network 105 and/or service platform 111 determine to store a record of the validation, the redemption, or a combination thereof. In one embodiment, the validation and/or redemption of the one or more coupons are stored in the coupon database 107 for further analysis (e.g., tracking, accounting, etc.) by, for example, the participating merchants, by the service platform 111, by the coupon services 103 and the like whereby the analysis information can be used, for example, to guide the coupon offerings.

In step 459, process and/or facilitate a processing of the record to generate one or more subsequent messages related, at least in part, to the coupon information. In one embodiment, the coupon services 103, communication network 105 and/or service platform 111 can determine one or more coupon subsequent information to a user based, at least in part, on prior information provided to the user. In an example, the coupon services 103, communication network 105 and/or service platform 111 check prior coupon access history of a user and dynamically modify the subsequent one or more coupon information provided to the user, for example, if the user has called for server coupons in the past the next coupon will offer a larger discount. In another example, if the user has called for a specific product at a specific vendor, the subsequent coupon can provide a better coupon at a different vendor.

In step 461, the at least one ring-back media file is a ring-back signal, and the at least one communication channel is a telephony network configured to support the ring-back signal.

In step 463, the communication network 105 determines one or more ring-back media types supported by the at least one communication channel. In one embodiment, the communication network 105 determines (e.g., via a central control unit) what types of media messages can be transmitted included and/or in place of a ring-back signal. For example, the media can include audio, video, text or a combination thereof. In one example, the coupon information can be sent as a text message whereby the user can make note of it, print it, store it in a user device, present it at a point-of-sale and/or the like. In another example, the coupon information can be sent as an audio message whereby the user can listen to the message, record it in a user device, store it in a user device, convert it to text, present it at a point-of-sale and/or the like.

In step 465, the communication network 105 causes, at least in part, generation of the at least one ring-back media file based, at least in part, on the one or more ring-back media types. In one embodiment, the coupon services 103 utilizes information on media types supported by the communication network 105 in order to generate one or more coupon information message types. For example, a particular service provider may only support a text message as a ring-back media type or another service provider may only support an audio media file.

In step 467, the communication network 105 causes the one or more ring-back media types to include, at least in part, an audio type, a video type, a text type, or a combination thereof. In one example, one or more service providers may support one or more media types to be used as ring-back media, which can depend on different parameters such as technical capability, costs, network traffic and/or the like.

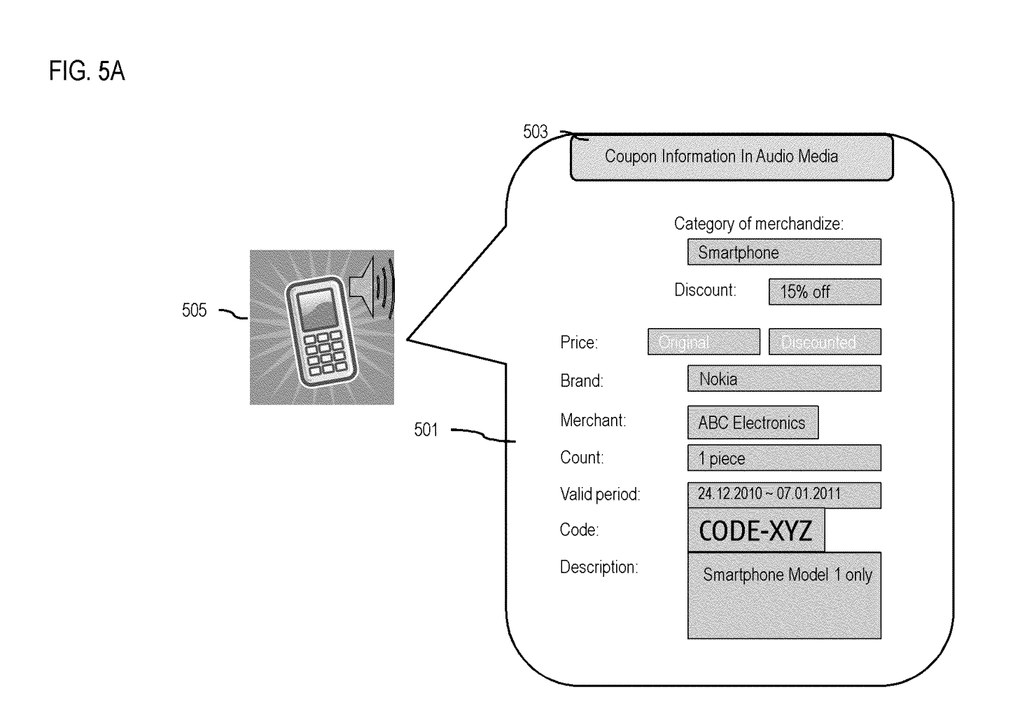

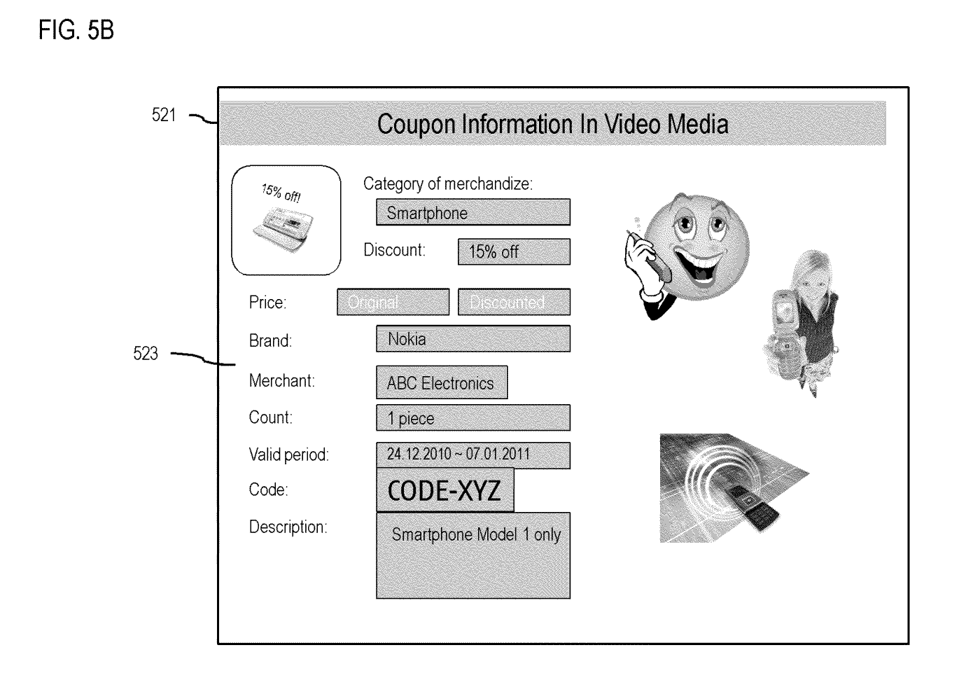

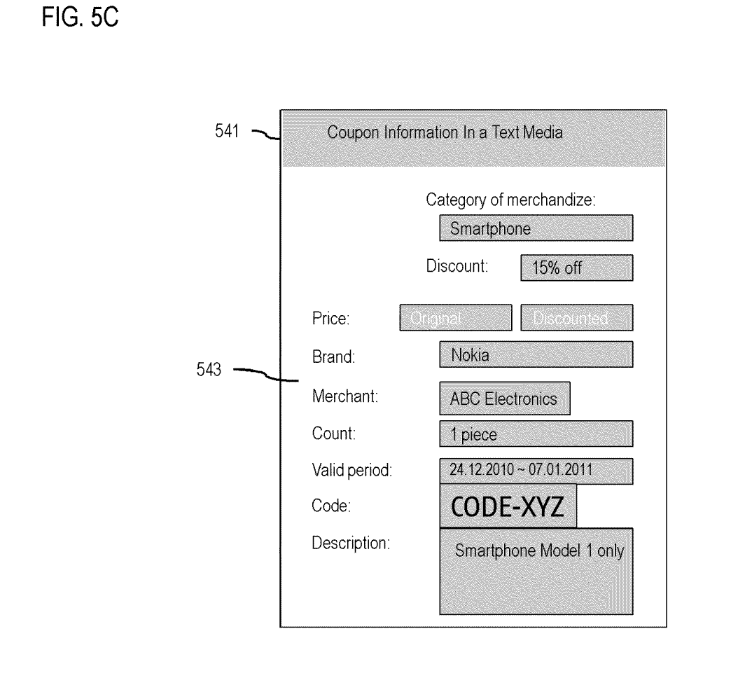

FIGS. 5A-5C are diagrams of user interfaces utilized in the processes of FIGS. 3-4, according to various embodiments. FIG. 5A depicts a coupon information 501 provided in audio format. In this example, the coupon information indicates a 15% discount when buying a Smartphone Model 1 during the Christmas season including attributes of the smartphone including, for instance, a price, a brand and other attribute fields. In one embodiment, as shown in FIG. 5A, the coupon information is presented to the user in an audio media format 503 whereby the information can be played and/or stored on a user device 505. For example, the user can play the audio media at the point-of-sale to present the coupon information to a merchant.

FIG. 5B depicts another example embodiment where the coupon information is presented in a video media format 521 whereby same/similar/more coupon information 523, as in FIG. 5A, can be presented to the user.

FIG. 5C depicts a user interface (UI) 501 that presents text and/or a template for providing coupon information in a text media format (e.g., over internet protocol calls/sessions). The coupon services 103 can provide the coupon information as free-format text or in the template of the UI 541, as in this example. In another example, the coupon information can be formatted into a machine readable image on the UE 101 display (e.g., barcode, pattern, etc.) such that the image can be scanned by a device (e.g., a scanner) in order to obtain the coupon information. In another example, the coupon information on a user device can be transferred to point-of-sale device via one or more wireless methods such as radio frequency, Bluetooth, near field communications (NFC), infrared and/or the like.

The processes described herein for providing coupon information in a ring-back signal may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

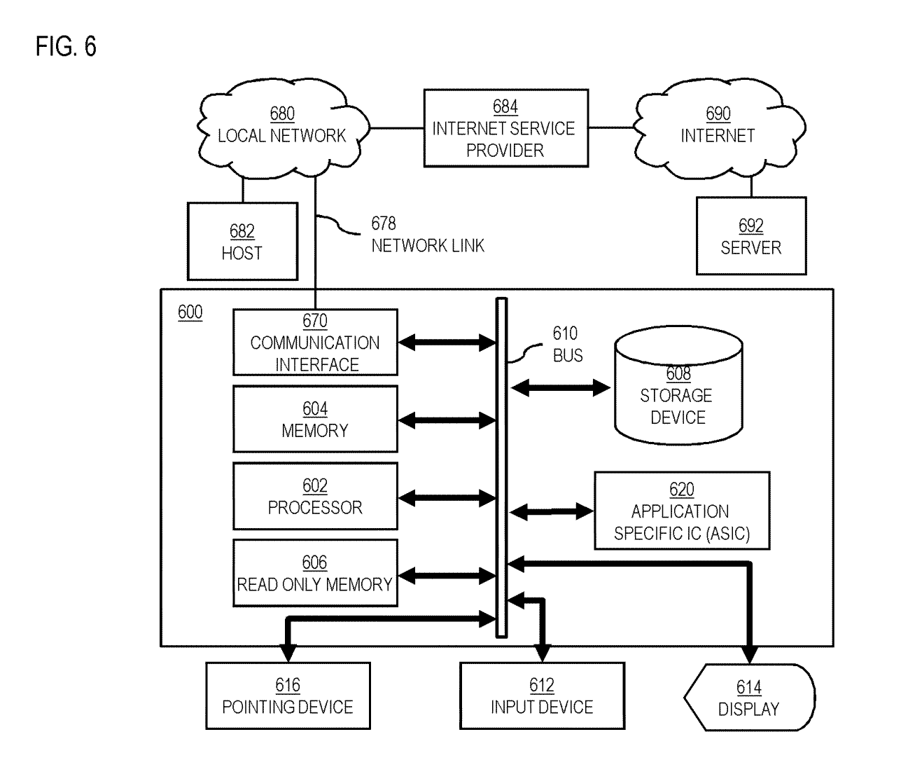

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide context-based coupon information access/delivery as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600 or a portion thereof, constitutes a means for performing one or more steps of providing context-based coupon information.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to providing coupon information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing coupon information. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing coupon information, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, which carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing coupon information to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide coupon information as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing coupon information.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide coupon information. The memory 705 also stores the data associated with or generated by the execution of the inventive steps.

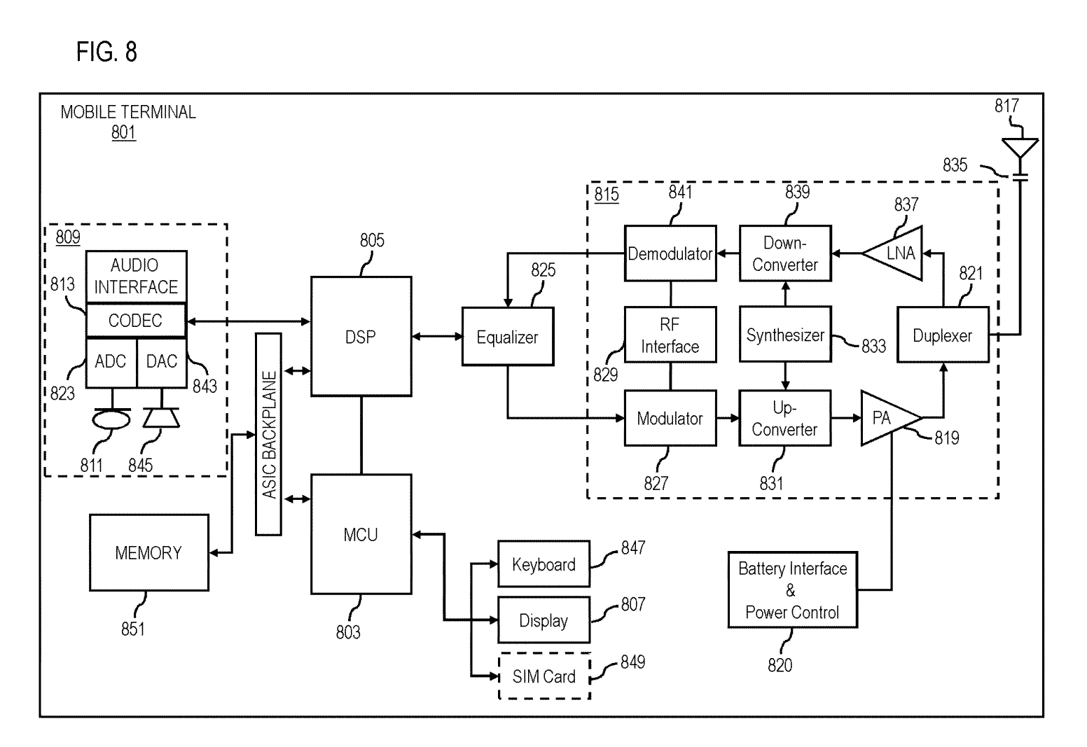

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing context-based coupon sharing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing coupon information. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide coupon information. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
processing and/or facilitating a processing of one or more messages of one or more applications, one or more services, or a combination thereof for presentation in at least one ring-back media file; and
determining to associate the at least one ring-back media file to at least one communication channel associated with (a) the one or more applications, (b) the one or more services, (c) at least one user of the one or more applications or the or more or services, or a combination thereof,
wherein a request to initiate a communication session over of the at least one communication channel causes, at least in part, a presentation of the at least one ring-back media file pending an establishment of the communication session.

2. A method of claim 1, further comprising:
processing and/or facilitating a processing of the request to initiate the communication session to determine identification information, context information, or a combination thereof associated with a device or a user of the device,
wherein the one or more messages, the processing of the one or more messages, or a combination thereof is based, at least in part, on the identification information, the context information, or a combination thereof.

3. A method of claim 1, wherein the processing of the one or more messages is performed prior to the request to initiate the communication session, or is triggered by the request to initiate the communication session.

4. A method of claim 1, wherein the at least one ring-back media file is a recording of the one or more messages, an encoding of the one or more message, or a combination thereof.

5. A method of claim 1, wherein the one or more applications, the one or more services, or a combination thereof relate to providing coupon information, the method further comprising:
causing, at least in part, a dynamic generation of the coupon information for the communication session.

6. A method of claim 5, further comprising:
causing, at least in part, selection of one or more words from a predetermined set of words to represent the coupon information,
wherein the one or more messages include, at least in part, the one or more words.

7. A method of claim 5, wherein the coupon information is presented at a retailer, the method further comprising:
receiving a request to validate the coupon information; and
processing and/or facilitating a processing of the coupon information for validation, redemption, or a combination thereof based, at least in part, on the one or more messages.

8. A method of claim 7, further comprising:
determining to store a record of the validation, the redemption, or a combination thereof; and
processing and/or facilitating a processing of the record to generate one or more subsequent messages related, at least in part, to the coupon information.

9. A method of claim 1, wherein the at least one ring-back media file is a ring-back signal, and the at least one communication channel is a telephony network configured to support the ring-back signal.

10. A method of claim 1, further comprising:
determining one or more ring-back media types supported by the at least one communication channel; and
causing, at least in part, generation of the at least one ring-back media file based, at least in part, on the one or more ring-back media types, wherein the one or more ring-back media types include, at least in part, an audio type, a video type, a text type, or a combination thereof.

11. An apparatus comprising:
at least one processor; and
at least one memory including computer program code for one or more programs, the at least one memory and the computer program code configured to, with the at least one processor, cause the apparatus to perform at least the following,
process and/or facilitate a processing of one or more messages of one or more applications, one or more services, or a combination thereof for presentation in at least one ring-back media file; and
determine to associate the at least one ring-back media file to at least one communication channel associated with (a) the one or more applications, (b) the one or more services, (c) at least one user of the one or more applications or the or more or services, or a combination thereof,
wherein a request to initiate a communication session over of the at least one communication channel causes, at least in part, a presentation of the at least one ring-back media file pending an establishment of the communication session.

12. An apparatus of claim 11, wherein the apparatus is further caused to:
process and/or facilitate a processing of the request to initiate the communication session to determine identification information, context information, or a combination thereof associated with a device or a user of the device,
wherein the one or more messages, the processing of the one or more messages, or a combination thereof is based, at least in part, on the identification information, the context information, or a combination thereof.

13. An apparatus of claim 11, wherein the processing of the one or more messages is performed prior to the request to initiate the communication session, or is triggered by the request to initiate the communication session.

14. An apparatus of claim 11, wherein the at least one ring-back media file is a recording of the one or more messages, an encoding of the one or more message, or a combination thereof.

15. An apparatus of claim 11, wherein the one or more applications, the one or more services, or a combination thereof relate to providing coupon information, the apparatus is further caused to:
cause, at least in part, a dynamic generation of the coupon information for the communication session.

16. An apparatus of claim 15, wherein the apparatus is further caused to:
cause, at least in part, selection of one or more words from a predetermined set of words to represent the coupon information,
wherein the one or more messages include, at least in part, the one or more words.

17. An apparatus of claim 15, wherein the coupon information is presented at a retailer, the apparatus is further caused to:
receive a request to validate the coupon information; and
process and/or facilitate a processing of the coupon information for validation, redemption, or a combination thereof based, at least in part, on the one or more messages.

18. An apparatus of claim 17, wherein the apparatus is further caused to:
determine to store a record of the validation, the redemption, or a combination thereof; and
process and/or facilitating a processing of the record to generate one or more subsequent messages related, at least in part, to the coupon information.

19. An apparatus of claim 11, wherein the at least one ring-back media file is a ring-back signal, and the at least one communication channel is a telephony network configured to support the ring-back signal.

20. An apparatus of claim 11, wherein the apparatus is further caused to:
determine one or more ring-back media types supported by the at least one communication channel; and
cause, at least in part, generation of the at least one ring-back media file based, at least in part, on the one or more ring-back media types,
wherein the one or more ring-back media types include, at least in part, an audio type, a video type, a text type, or a combination thereof.

21.-48. (canceled)
